(19) United States
(12) Patent Application Publication
(10) Pub. No.: US 2010/0026505 A1
(43) Pub. Date: Feb. 4, 2010

(54) DIGITAL PHOTO FRAME WITH BATTERY INDICATOR

(75) Inventors: HAN-CHE WANG, Tu-Cheng (TW); XIAO-GUANG LI, Shenzhen City (CN); YUNG-YI WANG, Tu-Cheng (TW); FENG ZHU, Shenzhen City (CN); FEN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/475,580

(22) Filed: May 31, 2009

(30) Foreign Application Priority Data
Jul. 31, 2008 (CN) 200820301665.6

(51) Int. Cl. G08B 21/00

(52) U.S. Cl. 340/636.15; 340/636.1; 340/815.45

(57) ABSTRACT

A digital photo frame (DPF) capable of indicating battery is provided. The DPF includes a light-emitting diode (LED) unit, a battery, a battery detection unit, a processing unit, and a display control unit. The battery detection unit is connected to the battery and is configured to detect the charge of the battery and output a low battery alarm signal when the charge of the battery is below a predetermined value. The processing unit is connected to the battery detection unit, and is configured to producing a control signal when receiving the low battery alarm signal. The display control unit is connected to the processing unit and the LED unit, and is configured to control the LED unit to change its display state when receiving the control signal.

### RELATED APPLICATIONS

This application is related to copending applications entitled, “DIGITAL PHOTO FRAME CAPABLE OF AUTOMATICALLY CHANGING DISPLAY MODE”, filed ______ (Atty. Docket No. US21363); “INTELLIGENT DIGITAL PHOTO FRAME”, filed ______ (Atty. Docket No. US21364); “DIGITAL PHOTO FRAME CAPABLE OF ATTRACTING ATTENTION”, filed ______ (Atty. Docket No. US21366); and “DIGITAL PHOTO FRAME CAPABLE OF ATTRACTING ATTENTION”, filed ______ (Atty. Docket No. US22333).

### BACKGROUND

1. Technical Field

The disclosure relates to electronic devices and, particularly, to a digital photo frame.

2. Description of Related Art

Nowadays, digital photos are getting more and more popular while digital cameras are becoming more and more affordable. Accordingly, in order to display digital photos, digital photo frames (DPFs) are invented.

A significant advantage DPFs have over traditional photo frames is that they are capable of storing a large number of media such as pictures, videos, audios. So, people can enjoy the media. However, the disadvantage of DPFs is their high power consumption. With battery powered DPFs a user may fail to charge the batteries in time.

Therefore, it is necessary to provide a digital photo frame to overcome the above-identified deficiency.

### BRIEF DESCRIPTION OF THE DRAWINGS

The components in the drawings are not necessarily drawn to scale, the emphasis instead being placed upon clearly illustrating the principles of the digital photo frame. Moreover, in the drawings, like reference numerals designate corresponding parts throughout the several views.

FIG. 1 is a block diagram of a digital photo frame in accordance with an exemplary embodiment.

FIG. 2 is a circuit diagram of a battery detection unit of the digital photo frame of FIG. 1, in accordance with an exemplary embodiment.

### DETAILED DESCRIPTION

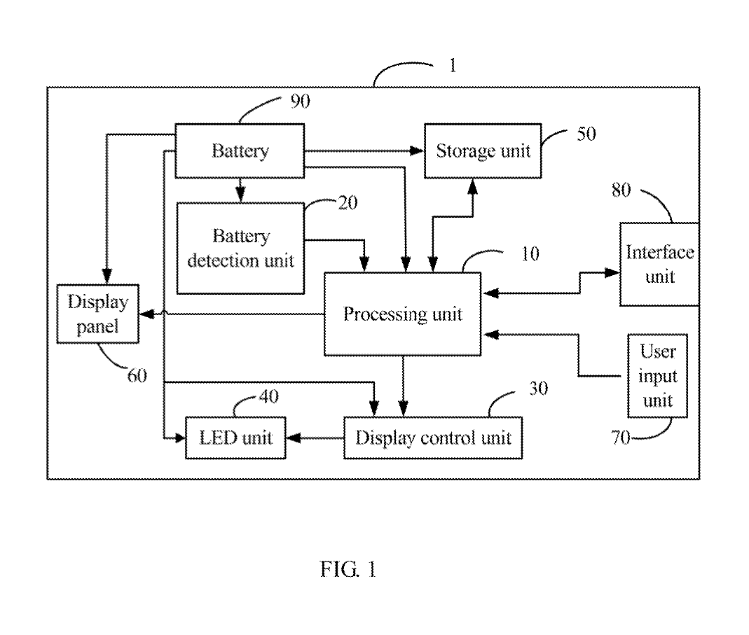

Referring to the FIG. 1, a digital photo frame (DPF) 1 includes a processing unit 10, a battery detection unit 20, a display control unit 30, a light-emitting diode (LED) unit 40, a storage unit 50, a display panel 60, a user input unit 70, an interface unit 80 (e.g., an input port or a wireless transceiver), and a battery 90. The DPF 1 is capable of controlling the LED unit 40 to change its display state when the battery is about to become exhausted.

The interface unit 80 is configured to connect to an external electronic device (not shown). The external device can be a storage card (e.g., a secure digital SD card, a compact flash CF card) or another electronic device (e.g., a digital camera, a mobile phone, or a computer).

The user input unit 70 is configured to generate instructions in response to user operations. The user input unit 70 can be input keys/buttons, knobs, and the like. The battery 90 is configured for providing power to elements of the DPF 1, such as the processing unit 10, the LED unit 40 and the display panel 60. In the embodiment, the LED unit 40 includes at least one LED.

The storage unit 50 is configured to store displayable media such as digital pictures. The display panel 60 is configured to display the media.

The battery detection unit 20, connected to the battery 90 and the processing unit 10, is configured for detecting the charge remaining in the battery, and producing an low battery alarm signal to the processing unit 10 when it detects the charge of the battery 90 is below a predetermined value. The processing unit 10 is configured for producing a control signal to the display control unit 30 when receiving the low battery alarm signal. The display control unit 30 is connected to the LED unit 40 and the processing unit 10, and is configured to control the LED unit 40 to change the display state when receiving the control signal. For example, the display control unit 30 controls the LED unit 40 to turn dark, or controls the LED unit 40 to flash.

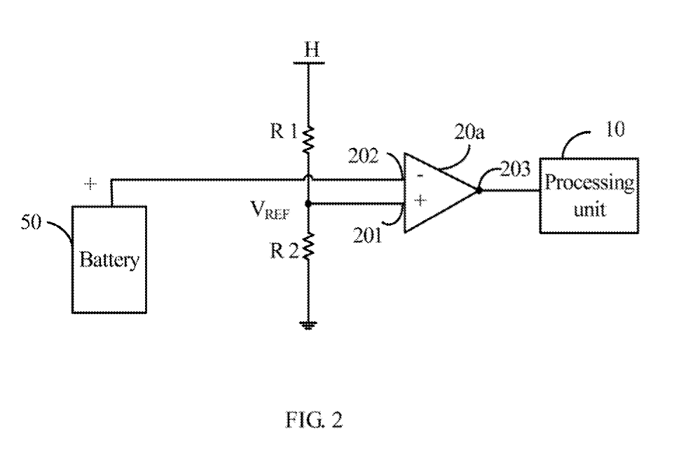

Referring also to FIG. 2, the battery detection unit 20 includes a comparison circuit 20a, resistors R1 and R2. The comparison circuit 20a includes a non-inverting port 201, an inverting port 202, and an output port 203. The inverting port 202 of the comparison circuit 20a is connected to an anode of the battery 90. The resistors R1 and R2 are serially connected between a positive potential point H and ground, a connection node of the resistor R1 and R2 is connected to the non-inverting port 201 of the comparison circuit 20a, the connection node of the resistors R1, R2 provides a reference voltages VREF to the non-inverting input port 201 of the comparison circuit 20a. The reference voltage is a predetermined value that indicates the charge state of the battery 90 when it is below or above the predetermined value. The output port 203 of the comparison circuit 20a is connected to the processing unit 10.

When the battery 90 is discharged, the charge of the battery 90 is decreased gradually and the voltage of the battery 90 declines too. When the voltage of the battery 90 is lower than the reference voltage, the output port 203 of the comparison circuit 20a outputs the alarm signal to the processing unit 10. In the embodiment, the alarm signal is a high voltage signal.

In other embodiments, the connection node of the resistor R1 and R2 is connected to the inverting port 202 of the comparison circuit 20a and provide the reference voltage VREF to the inverting input port 202, and the anode of the battery 90 is connected to the non-inverting port 201 of the comparison circuit 20a. When the voltage of the battery 90 is lower than the reference voltage VREF, the output port 203 of the comparison circuit 20a outputs a low voltage alarm signal.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A digital photo frame (DPF) comprising:
a light-emitting diode (LED) unit;
a battery detection unit configured for detecting charge of a battery of the DPF and producing a low battery alarm signal when detecting the charge of the battery is lower than a predetermined value;
a processing unit connected to the battery detection unit, and configured for producing a control signal when receiving the low battery alarm signal;
a display control module configured for controlling the LED unit to change its display state when receiving the control signal.

2. The DPF of claim 1, wherein the battery detection unit compares a voltage of the battery with a predetermined reference voltage to determine whether the charge of the battery is lower than the predetermined value.

3. The DPF of claim 2, wherein the battery detection unit comprises a comparison circuit, the comparison circuit comprises a non-inverting port which is provided as a reference voltage port to supply the predetermined reference voltage, an inverting port connected to an anode of the battery, and an output port connected to the processing unit, when the voltage of the battery is lower than the predetermined reference voltage, the output port of the comparison circuit outputs the alarm signal.

4. The DPF of claim 2, wherein the battery detection unit comprises a comparison circuit, the comparison circuit comprises an inverting port which is provided as a reference voltage port to supply the predetermined reference voltage, a non-inverting port connected to an anode of the battery, and an output port connected to the processing unit, when the voltage of the battery is lower than the predetermined reference voltage, the output port of the comparison circuit outputs the alarm signal.

5. The DPF of claim 4, wherein the alarm signal is a low voltage signal.

6. The DPF of claim 1, wherein the display control module controls the LED unit to turn dark thereby changing its display state.

7. The DPF of claim 1, wherein the display control module controls the LED unit to flash thereby changing its display state.

8. A method of indicating charge of a battery of a digital photo frame (DPF), the DPF comprising:
a light-emitting diode (LED) unit;
a battery detection unit;
a display control unit; and
a processing unit,
the method comprising:
detecting charge of a battery of the DPF via the battery detection unit;
producing an alarm signal when detecting the charge of the battery is lower than a predetermined value;
producing a control signal when the processing unit receives the alarm signal; and
controlling the LED unit to change its display state when the display control unit receives the control signal.

9. The method of claim 8, wherein the step of controlling the LED unit to change its display state when the display control unit receives the control signal comprising:
controlling the LED unit to turn dark thereby changing its display state.

10. The method of claim 8, wherein the step of controlling the LED unit to change its display state when the display control unit receives the control signal comprising:
controlling the LED unit to flash thereby changing its display state.
